(19) United States
(12) Patent Application Publication
(10) Pub. No.: US 2012/0266992 A1
(43) Pub. Date: Oct. 25, 2012

(54) ROCKER SWITCH WATERWAY MECHANISM

(75) Inventors: Huasong Zhou, Xiamen (CN); Yanhui Zhong, Xiamen (CN); Haisong Peng, Xiamen (CN); Bin Chen, Xiamen (CN); Jianmin Chen, Xiamen (CN); Bin Cao, Xiamen (CN)

(73) Assignees: XIAMEN SOLEX HIGH-TECH INDUSTRIES CO., LTD., Xiamen, Fujian (CN); Huasong ZHOU, Xiamen, Fujian (CN)

(21) Appl. No.: 13/517,130

(22) PCT Filed: Dec. 21, 2010
(86) PCT No.: PCT/CN2010/080040

§ 371 Date: Jun. 19, 2012

(30) Foreign Application Priority Data
Dec. 22, 2009 (CN) 200910215137.8
Dec. 22, 2009 (CN) 200920267592.8
Jun. 4, 2010 (CN) 201010192261.X

(51) Int. Cl. F16K 1/00

(52) U.S. Cl. 137/861

(57) ABSTRACT

The present invention is provides with a rocker switch waterway mechanism, which includes an inlet unit, at least two outlet units and a switch mechanism. The switch mechanism includes a rocker and switch valve pin jointed together, the switch valve is disposed inside the cavity of the connection of the two outlet units, and the rocker drives the switch valve moves between the inlets of the two outlet unit to realize the switch of the two outlet units. The present invention is provided with not much switch force, and the switch is convenient.

### FIELD OF THE INVENTION

The present invention relates to a waterway switch mechanism for a shower, especially to a rocker switch waterway mechanism.

### BACKGROUND OF THE INVENTION

The existing waterway switch of the shower has two types, one is rotation switch, the other is sliding switch. The sliding switch waterway mechanism, for example the Chinese patent ZL200520057077.9, the title of the patent for invention is a bath shower, which includes an inlet pipe disposed between the housing and the base. The outlet of the inlet pipe is disposed with sliding control device to regulate the output flowrate and the direction of the flow. The control device includes a sliding regulator moving repetitively horizontally, one end of the sliding regulator is disposed in the sliding groove between the fixed board and the inlet pipe, the sliding regulator is disposed with water hole, and the fixed board is disposed with at least two types of outlet holes of different size correspondingly. The other end of the sliding regulator is disposed with a bending, which is extended out of the base and connected to a pushing board disposed on the base surface; the outlet of the inlet pipe is disposed with outlet sleeve, which is pressed on the outlet holes of the sliding board. In this proposal, the sliding regulator slides by the pushing of the pushing board, then the water hole chooses different outlet holes, realizing the flowing direction (the waterway) switch. As in this waterway switch mechanism, the sliding of the sliding regulator is realized by pushing the pushing board, it has the disadvantages below: 1. it needs more switch forth with inconvenient; 2. the pushing board is disposed outsider, the dust is easy to enter into the pushing board and the base surface, resulting stuck performance.

### SUMMARY OF THE INVENTION

The present invention is provided with a rocker switch waterway mechanism, which solves the problem of the background of the sliding waterway switch mechanism

The technical proposal of the present invention to solve the above technical problem is:

A rocker switch waterway mechanism includes an inlet unit, at least two outlet units and a switch mechanism, the switch mechanism includes a rocker and switch valve pin jointed together, the switch valve is disposed inside the cavity of the connection of the two outlet units, the rocker drives the switch valve to move between the inlets of the two outlet unit to realize the switch of the two outlet units.

In another preferred embodiment, the rocker switch waterway mechanism is connected to a first outlet unit and a second outlet unit, the switch mechanism includes an external pipe, an inner pipe, a connection base, a rocker and a switch valve; the external pipe is sleeved with the inner pipe and formed with an inlet cavity between the inner pipe and the external pipe to connect to the water source; the inner pipe is disposed with an inlet and an outlet, the outlet is connected to the first outlet unit; the connection base is fixed at the end of the external pipe and connected to the second outlet unit, the connection base is disposed with a water hole connected to the inlet cavity and the second outlet unit; the rocker is inserted into the connection base and swung between a first position and a second position relative to the connection base; the switch valve is connected to the rocker and slided inside the connection base; the water hole is sealed by the switch valve when the rocker is situated in the first position, the inlet cavity is connected to the inlet of the inner pipe, the water flows from the first outlet unit, the inlet is sealed by the switch valve when the rocker is situated in the second position; the inlet of the inner pipe is connected to the water hole, the water flows from the second outlet unit.

In another preferred embodiment, the connection base includes a first water diversion body fixed in the lower of the external pipe and a joint fixed in the first water diversion body, the first water diversion body is hollow to form the water hole, the central of which is disposed with a circular boss.

In another preferred embodiment, the switch valve disposed with a sealing is passed through the water hole freely, the bottom surface of the sealing is withstood on the circular boss to seal the water hole when the rocker is situated in the first position; the inlet is sealed by the top surface of the sealing when the rocker is situated in the second position.

In another preferred embodiment, the rocker is disposed with an operating portion outside the connection base for the user's operation and a linkage portion inserted inside the connection base, the linkage portion is concaved disposed with a spherical cap groove of urn shaped; a sphere is disposed in the lower of the switch valve; the sphere is coupled to be accommodated inside the spherical cap groove, making the swinging of the rocker drive the switch valve to slide up and down.

In another preferred embodiment, the joint is disposed with an assembly groove, a waterway through up and down and an assembly hole connected to the assembly groove from up to down, the waterway is connected to the water hole of the first water diversion body and the second outlet unit, the lower of the switch valve is sealed and slided through the assembly hole, the linkage portion of the rocker is situated inside the assembly groove and connected to the lower of the switch valve.

In another preferred embodiment, the connection base further includes a second water diversion body, which includes an external sleeve, an inner sleeve and an interval connected the external sleeve and the inner sleeve, the upper of the external sleeve is sealed and screwed inside the external pipe, the lower of the external pipe is sealed and screwed inside the first water diversion body, the lower end face of the second water diversion body and the circular boss of the first water diversion is interval arranged, the inner sleeve is sealed and sleeved outside the inlet of the inner pipe.

In another preferred embodiment, the switch mechanism further includes a three way valve, which includes a first pipe connected to the water source, a second pipe and a third pipe, the second pipe is disposed with a first waterway connected to the first pipe and the inlet cavity and a second waterway connected to the outlet of the inner pipe and the first outlet unit.

In another preferred embodiment, the rocker switch waterway mechanism further includes a cover, which is coupled to be sealed and fixed to the opening of the assembly groove, a jack is opened on the cover; fulcrums are separately disposed on the upper and lower side face of the jack, the outer end of the rocker is extended out of the connection base from the jack of the cover.

In another preferred embodiment, the shape of the jack on the cover is coupled to the shape of the outer surface of the rocker, the fulcrum is hemispherical.

In another preferred embodiment, the rocker switch waterway mechanism further includes a fixed unit, an operation unit, a water diversion unit and at least two waterway; thereinto:

The operation unit includes a rocker, the rocker is pin jointed to the fixed unit and disposed with a handle outside the fixed unit for the operation of the user and a control portion inside the fixed unit, a inner gear is disposed on the control portion;

The water diversion unit includes a driven gear rotationally disposed inside the fixed unit and a water diversion disk fixed to the driven gear of coaxial; the inner gear is engaged to the driven gear, the driven gear and the water diversion disk are rotated by the driven of the rotation of the rocker, the switch of different waterways is realized by the relative rotation of the water diversion disk and the fixed unit.

In another preferred embodiment, the control portion includes a fanning strip and a barricade extended downward from the outer arc ridge of the fanning strip, the inner side wall of the barricade is disposed with an inner gear, the centre of the circle of the fanning strip is fixed to the handle.

In another preferred embodiment, the handle includes a pin joint portion pin jointed to the fixed unit and a handle rod fixed to the pin joint portion, the handle rod is fixed in the lower of the pin joint portion, the fanning strip is fixed in the upper of the pin joint portion.

In another preferred embodiment, the fixed unit includes a body, the operation unit is situated on the top face of the body, the water diversion unit disposed on the bottom surface of the body includes a water diversion body coupled to the water diversion disk, the water diversion body is disposed with several water diversion holes separately connected to different waterway.

In another preferred embodiment, a groove is disposed on the bottom surface of the body, the water diversion disk is coupled to be accommodated inside the groove.

In another preferred embodiment, a shaft disposed in the lower of the driven gear to be fixed to the water diversion unit of coaxial.

In another preferred embodiment, the fixed unit is disposed with a groove, the handle rod is extended out of the groove for the control of the user and can be swung left and right inside the groove.

In another preferred embodiment, a socket is disposed in the fixed unit.

Compared to the existing technology, the present invention has the advantages below: firstly, the waterway switch is realized by the swinging of the rocker driven the sliding of the switch valve with not much switch force, the switch is convenient. Even contact the dust, it will not influence the swinging of the rocker, the service life is longer and the performance of fault is low, serving a new switch for the user. Secondly, it turns out a total inlet waterway (the inlet cavity) and a water diversion waterway (inside the inner pipe) by the cooperation of the external pipe and the inner pipe, so the switch valve of the switch mechanism can be served in the position without the three way valve (not inside the three way valve or the three way pipe), but the place user controls for the convenient of the design. Thirdly, the connection portion of the rocker is disposed with a spherical cap groove, the lower of the switch valve is disposed with a sphere, which is coupled to connect to the prefer one, making the swinging of the rocker driving the switch valve sliding up and down, enhancing the accuracy of the switch valve. Fourthly, the assembly groove and the outlet waterway in the joint is disconnected, to ensure the sealing performance. Fifthly, a circular boss is disposed at the central of the water hole, to ensure that the water hole is sealed with the free sliding of the switch valve and the water hole.

There are further some advantages below in the present invention: 1. the rocker of the present invention is cooperated to the water diversion unit of the switch valve, the fixed unit and the waterway, the user can switch the handle rod of the rocker directly to switch the outlet of the switch valve, the switch is in a novel style with convenient usage, ingenuous structure and well sealing performance; 2. the rocker includes a handle and a control portion, the control portion includes a fanning strip and a barricade, the fanning strip is fixed to the handle, the barricade is engaged to the driven gear, so the cooperation is tightly with well interaction; 3. the handle is pin jointed to the fixed unit through the pin joint portion, the pin joint portion is fixed to the handle rod and the fanning strip, to ensure the operation unit cooperated to the fixed unit and the sealing performance as well; 4. as the water diversion unit includes a several water body with several water diversion holes, it is cooperated to the operation unit and separately connected to different waterways; 5. as a flanged shaft is disposed in the lower of the driven gear, it is connected to the water diversion unit of coaxial with effect; 7. as a groove is disposed in the fixed unit, when the handle rod of the rocker is extended out of the fixed unit, the rocker can swing left and right within the scope the groove limited; 8. a socket is disposed in the fixed unit, it can be used to hold the shower or put some odds.

### BRIEF DESCRIPTION OF THE DRAWINGS

The present invention is further described with the figures and the embodiment.

FIG. 1 illustrates the structure of the rocker switch waterway mechanism of the first embodiment of the present invention.

FIG. 2 illustrates the explosion view of the rocker switch waterway mechanism of the first embodiment of the present invention.

FIG. 3 illustrates the explosion view of the connection base, the switch valve, the rocker of the rocker switch waterway mechanism of the first embodiment of the present invention.

FIG. 4 illustrates the sectional view of the rocker switch waterway mechanism of the first embodiment of the present invention when the rocker switch waterway mechanism is situated in the intermediate state.

FIG. 5 illustrates the sectional view of the rocker switch waterway mechanism of the first embodiment of the present invention when the rocker switch waterway mechanism is situated in the second outlet unit state.

FIG. 6 illustrates the sectional view of the rocker switch waterway mechanism of the first embodiment of the present invention when the rocker switch waterway mechanism is situated in the first outlet unit state.

FIG. 7 illustrates the structure of the rocker switch waterway mechanism of the first embodiment of the present invention in application.

FIG. 8 illustrates the structure of the rocker switch waterway mechanism of the second embodiment.

FIG. 9 illustrates the explosion view of the rocker switch waterway mechanism of the second embodiment.

FIG. 10 illustrates the cooperation of the operation unit, the water diversion disk and the body in the second embodiment.

FIG. 11 illustrates the structure of the rocker switch waterway mechanism of the second embodiment applied in the head shower.

FIG. 12 illustrates the sectional view of the rocker switch waterway mechanism of the FIG. 9.

FIG. 13 illustrates the sectional view of the E-E line of the FIG. 9.

FIG. 14 illustrates the sectional view of the F-F line of the FIG. 9.

FIG. 15 illustrates the structure of the rocker switch waterway mechanism of the second embodiment applied in the side spray shower.

FIG. 16 illustrates the sectional view of the rocker switch waterway mechanism of the FIG. 15.

FIG. 17 illustrates the sectional view of the E-E line of the FIG. 15.

FIG. 18 illustrates the sectional view of the F-F line of the FIG. 15.

FIG. 19 illustrates the structure of the rocker switch waterway mechanism of the second embodiment applied in the handheld shower.

FIG. 20 illustrates the sectional view of the rocker switch waterway mechanism of the FIG. 19.

FIG. 21 illustrates the sectional view of the E-E line of the FIG. 19.

FIG. 22 illustrates the sectional view of the F-F line of the FIG. 19.

### DETAILED DESCRIPTION OF THE EMBODIMENT

### The First Embodiment

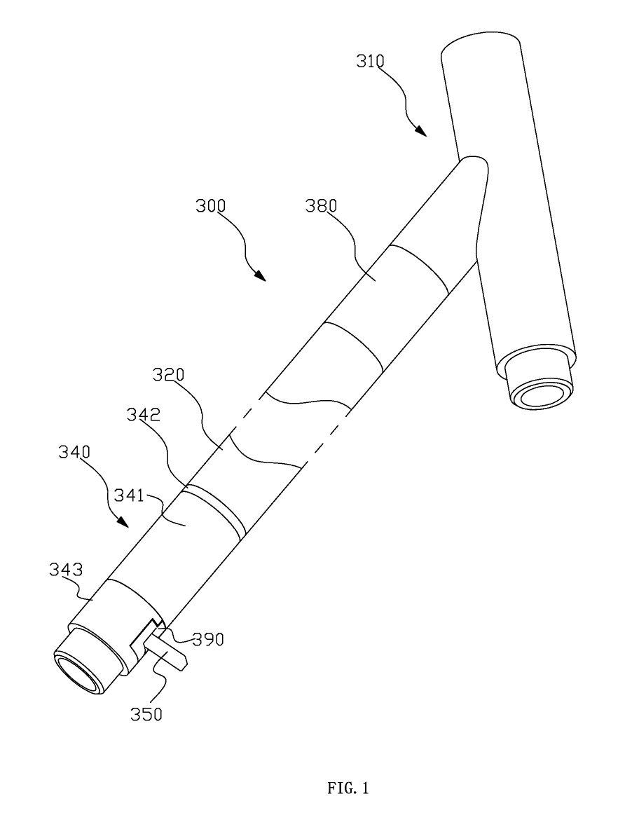

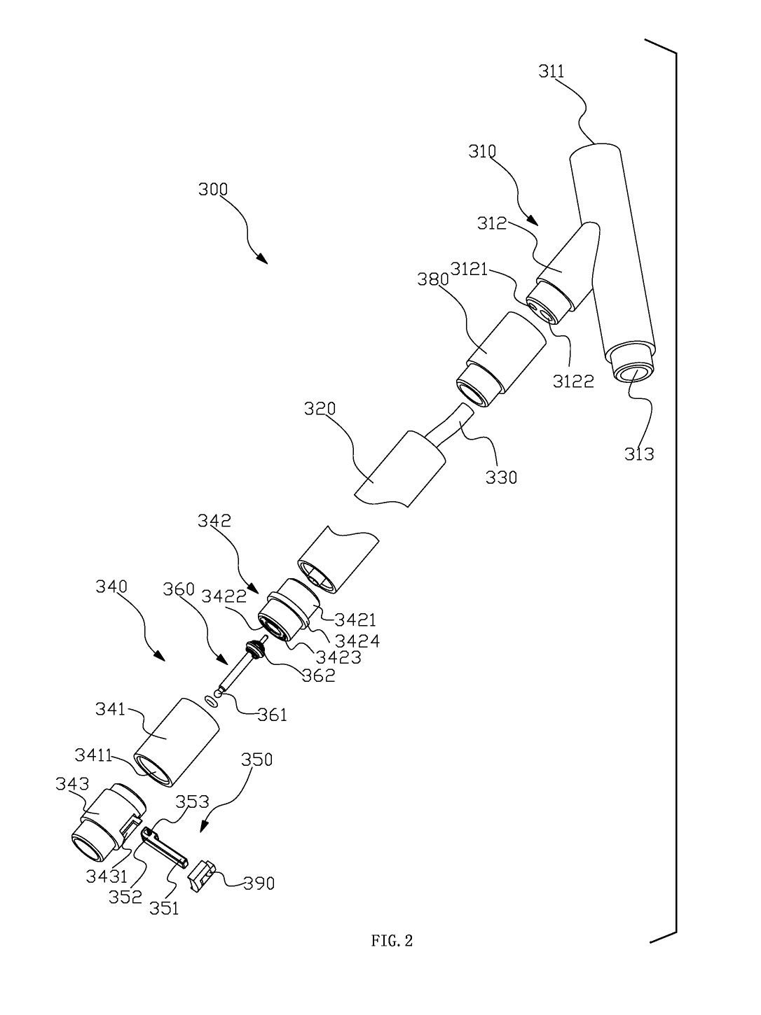

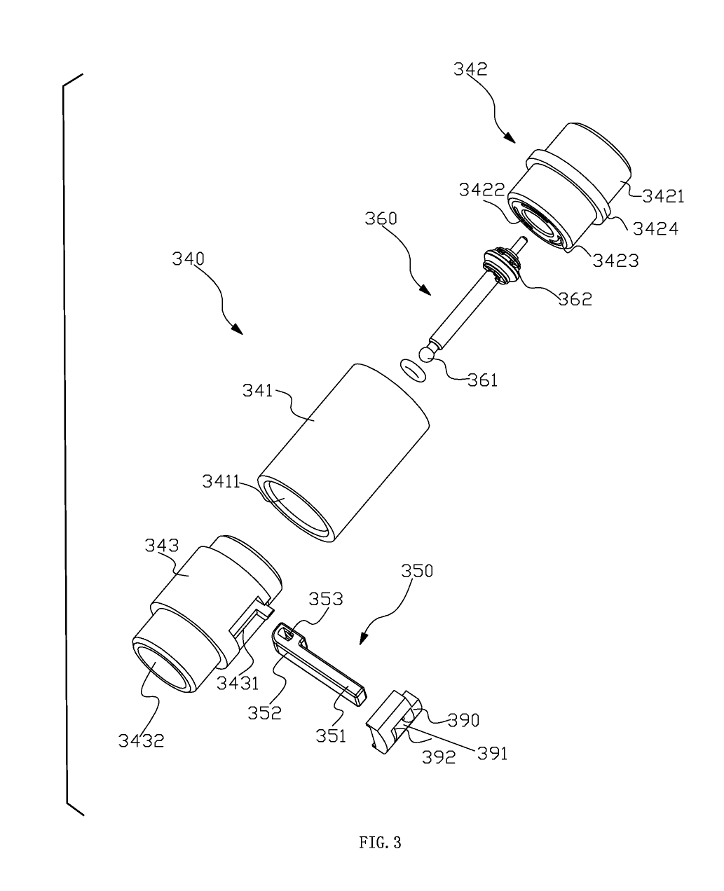

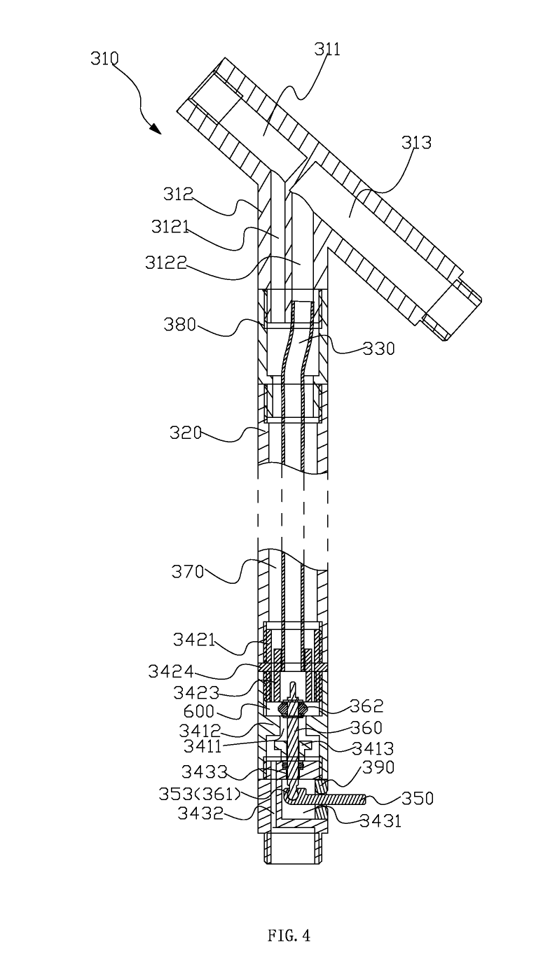

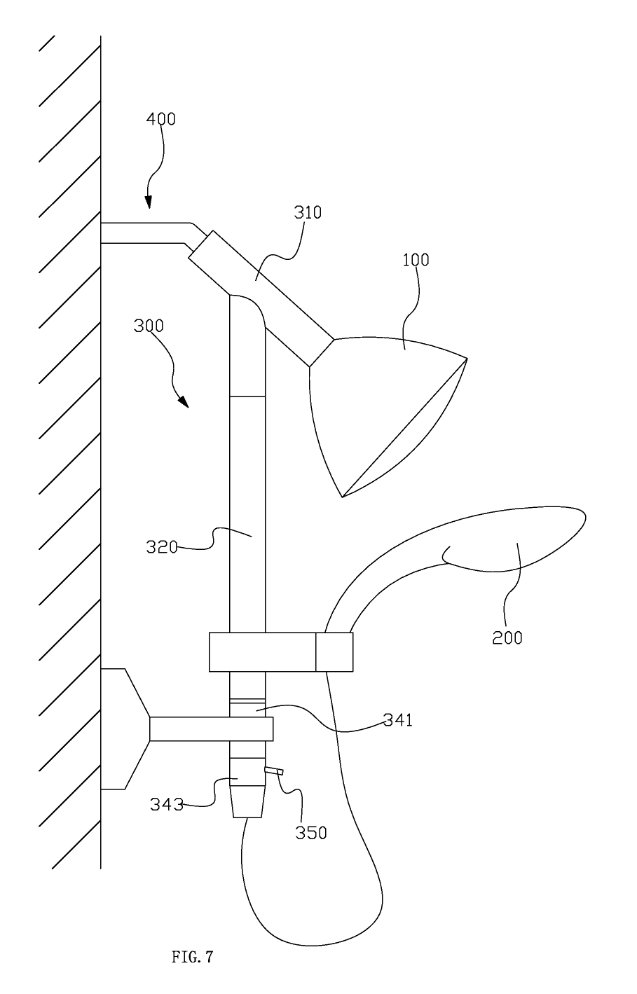

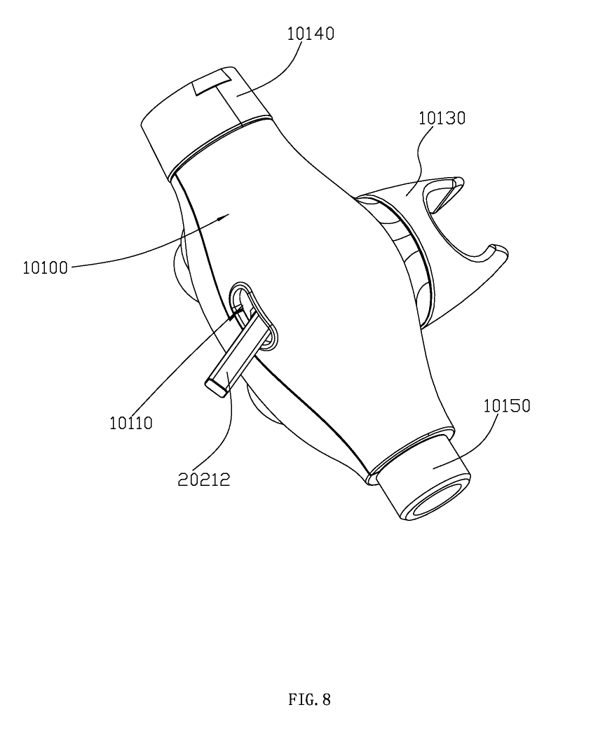

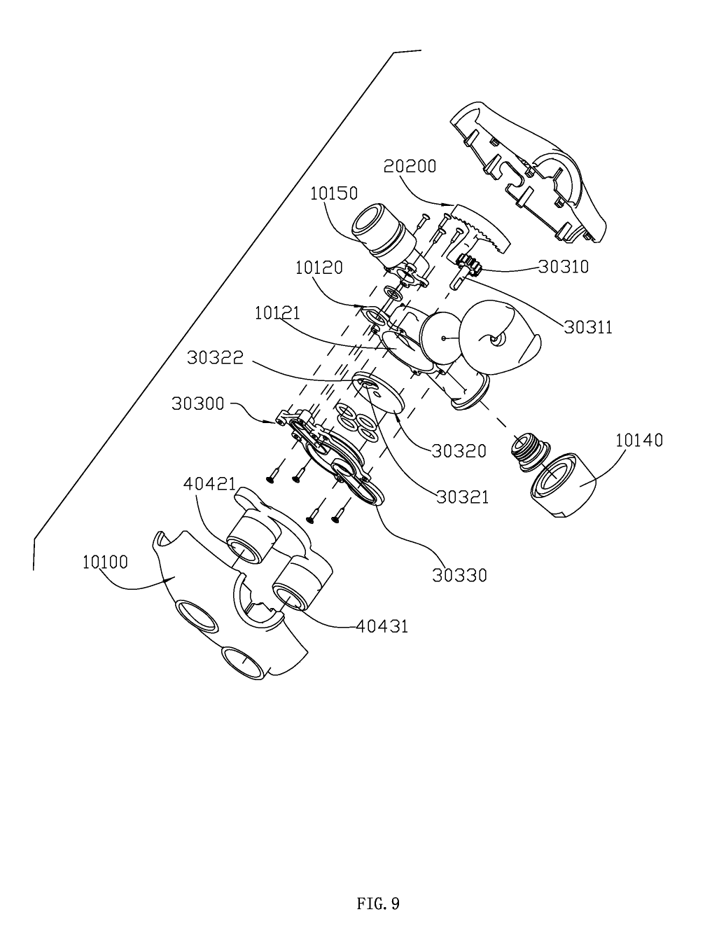

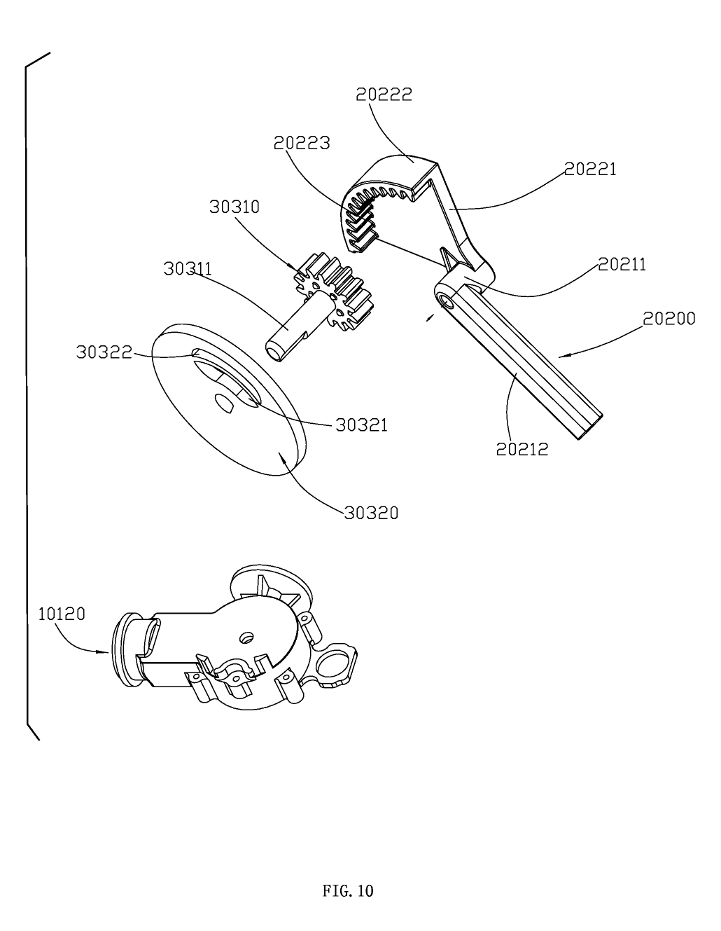

Please refer to the FIG. 1 to the FIG. 7 of the structure of the rocker switch waterway mechanism of the present invention.

The rocker switch waterway mechanism, as figured in the FIG. 7, is connected to a first outlet unit 100 and a second outlet unit 200. The first outlet unit 100 in this embodiment is a head shower, and the second outlet 200 is a handheld shower.

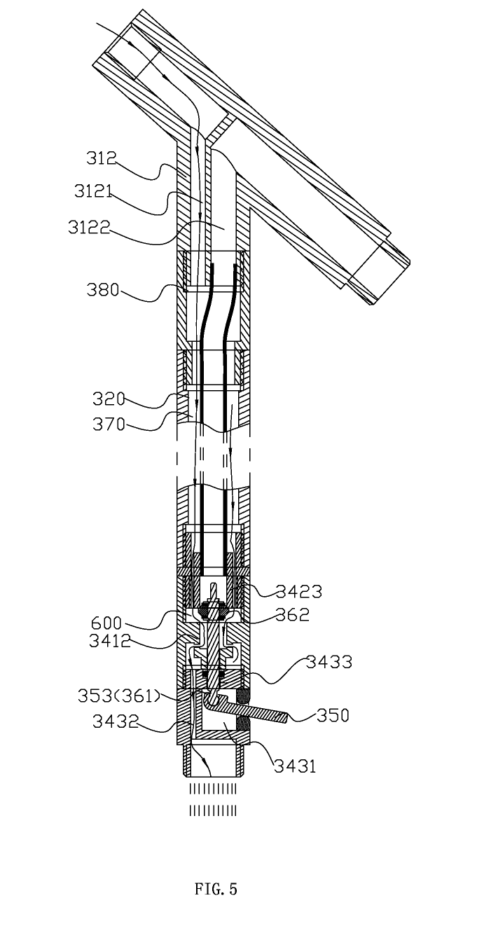

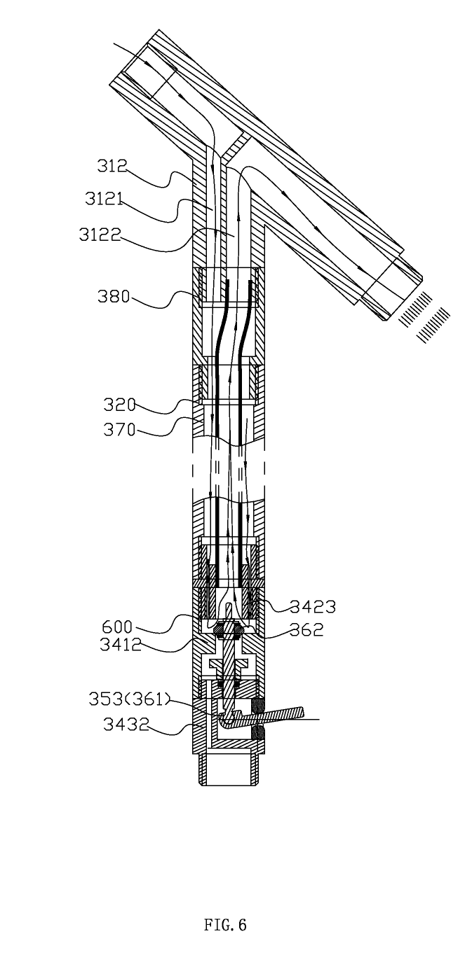

Please refer to the FIG. 1 to the FIG. 6, the switch mechanism 300 includes a three way valve 310, an external pipe 320, an inner pipe 330, a connecting base 340, a rocker 350, a switch valve 360 and a cover 390. The three way valve 310 includes a first pipe 311 fixed in the supporting arm 400 of the American shower and connected to the water source, a second pipe 312 and a third pipe 313. The second pipe 312 is disposed with a first waterway 3121 and a second waterway 3122. The first waterway 3121 is connected to the first pipe 311 to connect to the water source; the second waterway 3122 is connected to the third pipe 313. The third pipe 312 is disconnected to the first pipe 311.

The inner pipe 330 is fixed and sleeved to the external pipe 320 (the fixation is such as that rail rings with through holes are fixed between the both), forming an inlet cavity 370 situated between the inner pipe 320 and the external pipe 330. The external pipe 320 is fixed to the three way valve 310, making the first waterway 3121 connected to the inlet cavity 370 and the water passing through the first pipe 311, the first waterway 3121 then into the inlet cavity 370. For fixation convenient, a second joint 380 is connected between the external pipe and second pipe of the three way valve.

The inner pipe 320 is disposed with an inlet and outlet of up and down arranged. The outlet is connected to the second waterway 3122; the third pipe 313 is connected to the first outlet unit 100.

The connecting base 340 includes a first water diversion body 341, a second water diversion 342, a first joint 343.

The first water diversion body 341 is hollow to be a water hole 3411, the central of which is raised with a circular boss 3412. According to the need, a guide sleeve 3413 is disposed inside the first water diversion body 341 for guiding the switch valve.

The second water diversion body 342 includes an external sleeve 3421, an inner sleeve 3422, an interval 3423 connected between the external sleeve 3421 and the inner sleeve 3422 and a shaft boss 3424 fixed at the central of the external rotation surface of the external sleeve 3421. the upper of the external sleeve 3421 is sealed and screwed inside the external pipe 320, and the lower of the external sleeve 3421 is sealed and screwed inside the water hole 3411 of the first water diversion body 341, making that: the shaft boss 3424 is contact between the lower end face of the external pipe 320 and the upper end face of the first water diversion body 341, making the lower end face of the second water diversion body 342 and the circular boss 3412 of the first water diversion body 341 interval disposed, forming an outlet cavity 600, making the inner sleeve 3422 sealed and sleeved outside the outlet of the inner pipe 330.

The joint 343 is disposed with an assembly groove 3431 partially concaved inwards on the external rotation surface, a waterway 3432 through up and down and divorced from the assembly groove 3431 and a assembly hole 3433 connected to the assembly groove 3431 from up to down. The upper of the joint 343 is sealed and screwed inside the water hole 3411 of the first water diversion body 341, making the waterway 3432 connected to the water hole 3411. the lower of the rocker 343 is fixed with the second outlet unit 200 and connected to the waterway 3432.

The cover 390 is coupled to be sealed and fixed to the opening of the assembly groove 3431. A jack 391 is opened on the cover 390; the shape of the jack 391 is coupled to the shaped of the external face of the rocker 350. A fulcrum 392 of hemispherical is separately disposed on the upper and lower side face of the jack 391.

The rocker 350 is inserted into the cover 390 and swung between the first position and the second position relative to the cover 390. The rocker 350 includes an operating portion 351 outside the cover 390 for the operation of the user and a linkage portion 352 inserted into the cover 90 and inside the assembly groove 3431. The linkage portion 352 is concaved disposed with a spherical cap groove 353 of urn shaped.

A sealing 362 is fixed about the periphery of the end of the switch valve 360. The outer diameter of the switch valve 360 is smaller than the internal diameter of the water hole 3411. The upper of the switch valve 360 is passed through the water hole 3411 freely. A sphere 361 is fixed on the lower of the switch valve 360, and sealed and sliding through the assembly hole 3433 of the joint 343 to insert into the assembly groove 3431, making the sealing 362 positioned on the circular boss 3412. As there is only the assembly hole between the assembly groove 3431 and the water hole 3411, it prevents the water flowing into the assembly groove when the assembly hole is sealed. As the assembly hole is sliding connected to the switch valve, the sealing performance is well. The sphere 361 is coupled positioned inside the spherical cap groove 353, making the swinging of the rocker 350 driving the switch valve 360 sliding up and down.

The bottom face of the sealing 362 of the switch valve 360 is placed on the circular boss 3412 to seal the water hole 341 and cut off the connection of the outlet cavity 600 and the water hole 3411 when the rocker 350 is positioned in the first position. The water in the inlet cavity flows through the outlet cavity 600 into the inner sleeve 3422, then goes through the inlet of the inner pipe 330 and the second waterway 3122, the water flows out from the first outlet unit 100. The inner sleeve 3422 is sealed by the top surface of the sealing 360 of the switch valve 360 and the connection of the outlet cavity and the inner sleeve is cut off when the rocker 350 is positioned in the second position, the water in the inlet cavity 370 flows through the outlet cavity 600 and the water hole 3411 then into the waterway 3432, then the water flows out from the second outlet unit 200.

For the officer further understanding the present invention, the switch method of the jointer head switch waterway mechanism is detailed described.

The user presses the operating portion 351 of the rocker 350, with the fulcrum 392 of the cover 390 in the first joint 343, the linage portion moves upward about the fulcrum 392. The linkage portion 352 drives the switch valve 360 sliding upwards. The top surface of the sealing of the switch valve 360 is sealed and withstood on the inner sleeve 3422. Meanwhile the rocker 350 is situated in the second position, the inner sleeve 3422 is sealed by the top surface of the sealing of the switch valve 360, the connection of the outlet cavity and the inner sleeve is cut off, the water in the inlet cavity 370 flows through the outlet cavity 600, the water hole 3411 and then the wateout way 3432, the water flows from the second outlet unit 200.

The user raises the operating portion 351 of the rocker 350, with the fulcrum 392 of the cover 390 in the first joint 343, the linage portion moves downward about the fulcrum 392. The linkage portion 352 drives the switch valve 360 sliding downwards. The bottom surface of the sealing of the switch valve 360 is sealed and withstood on the top surface of the circular boss 3412. Meanwhile the rocker 350 is situated in the first position, the bottom surface of the sealing 362 of the switch valve 360 is withstood on the circular boss 3412 to seal the water hole 3411 and cut off the connection of the outlet cavity 600 and the water hole 3411. The water in the inlet cavity 370 flows through the outlet cavity 600, the inner sleeve 3422, and the inlet of the inner pipe 330 and then the second waterway 3122. The water flows from the first outlet unit 100.

### The Second Embodiment

Please refer to the FIG. 8 to the FIG. 22, they illustrates the structure of the rocker switch waterway mechanism of the preferred embodiment of the present invention.

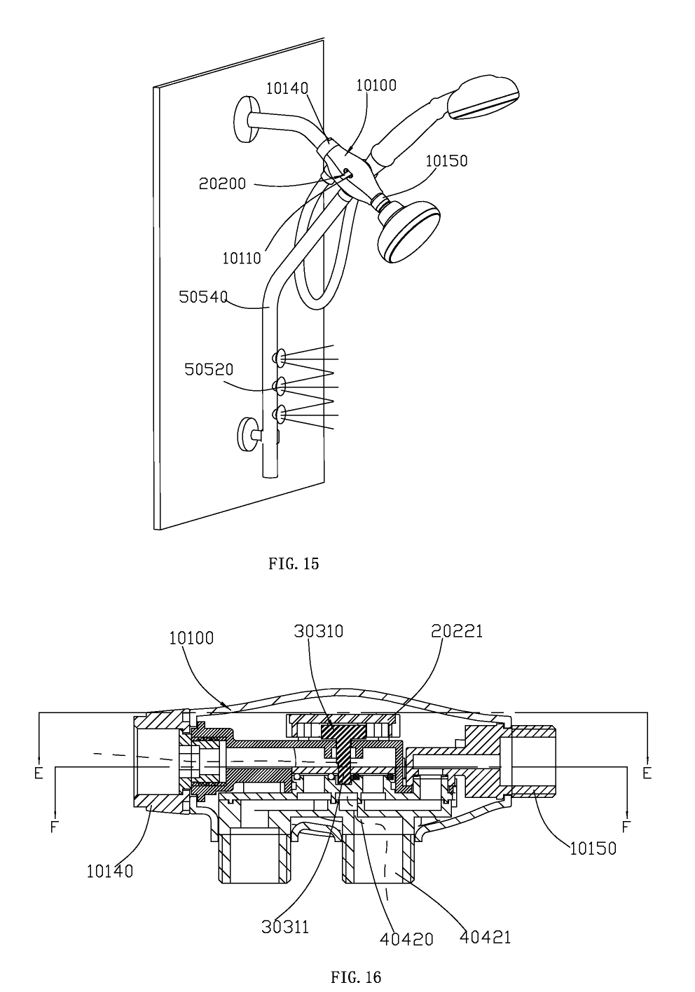

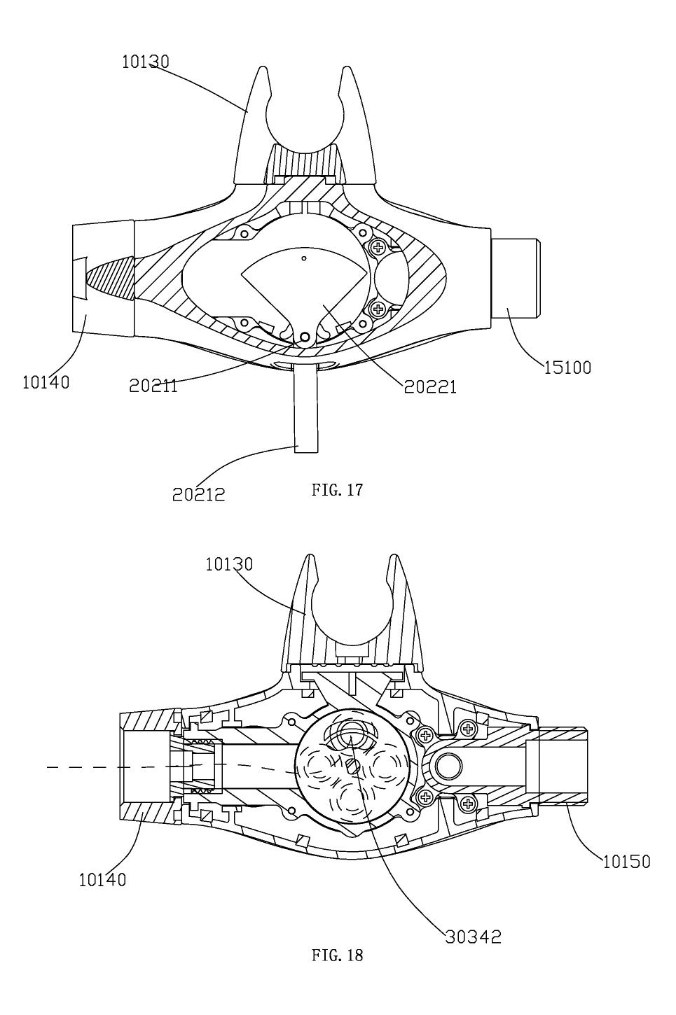

As figured in the FIG. 15 to the FIG. 17, the rocker switch waterway mechanism includes a fixed unit 10100, an operation unit, a water diversion unit 30300 and three waterways 40410, 40420 and 40430, thereinto:

The fixed unit 10100 is disposed outside the operation unit and the water diversion unit 30300. the fixed unit 10100 is disposed with a groove 10110 and a socket 10130. One end of the fixed unit 10100 is disposed with an inlet joint 10140 to connect to the water source, and the other end is disposed with an outlet joint 10150. The fixed unit 10100 further includes a body 10120 disposed inside. The both ends of the body 10120 are separately fixed to the inlet joint 10140 and the outlet joint 10150, the bottom of the body 10120 is disposed with a groove 10121.

The operation unit disposed above the body 10120 includes a rocker 10200, which includes a handle outside the fixed unit 10100 for the user's control and a control portion disposed inside the fixed unit 10100. The handle includes a pin joint portion 20211 and a handle bar 20212. The handle bar 20212 can swing left and right inside the groove 10110, the operation unit is pin jointed to the fixed unit 10100 through the pin joint portion 20211, and the handle bar 20212 is fixed to the lower of the pin joint portion 20211. The control portion includes a fanning strip 20221 and a barricade 20222 extended downward from the outer arc ridge of the fanning strip 20221. The centre of the circle of the fanning strip 20221 is fixed in the upper of the pin joint portion 20211 to fix the handle; the inner side wall of the barricade 20222 is disposed with an inner gear 20223.

The water diversion unit 30300 includes a driven gear 30310, a water diversion disk 30320 and a water diversion body 30330, thereinto:

The driven gear 30310 is disposed on the top surface of the body 10120; the water diversion disk 30320 and the water diversion body 30330 are situated on the bottom surface of the body 10120.

The driven gear 30310 is a gear, which is engaged to the inner gear 20223 of the barricade 20222 of the control portion to link to the operation unit. a flanged shaft 30311 is disposed in the lower of the driven gear 30310. the flanged shaft 30311 is run through the water diversion disk 30320, the body 10120 and the water diversion body 30330 in order. So the driven gear 30310, the water diversion disk 30320 and the water diversion body are rotated with the same axle with the control portion. The water diversion unit 30300 is rotated related to the fixed unit 10100 when switching the rocker 20200. A pair of the water hole 30321 and 30322 is disposed on the water diversion unit 30300. The water diversion disk cooperated to the water diversion body 30330 is couple to be accommodated inside the groove 10121 of the body 10120. Some water diversion holes connected to different waterways are disposed on the water diversion body 30330. In this embodiment, the switch valve has three waterways, the corresponding water diversion holes are 30341, 30342. 30343 with refer to the FIG. 14, FIG. 18 and the FIG. 22.

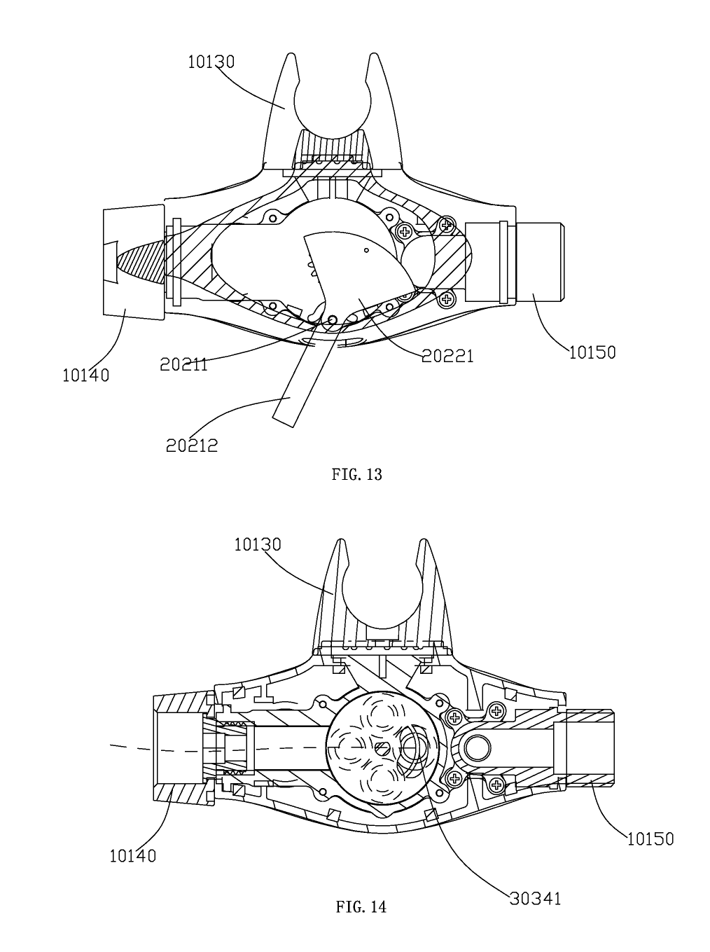

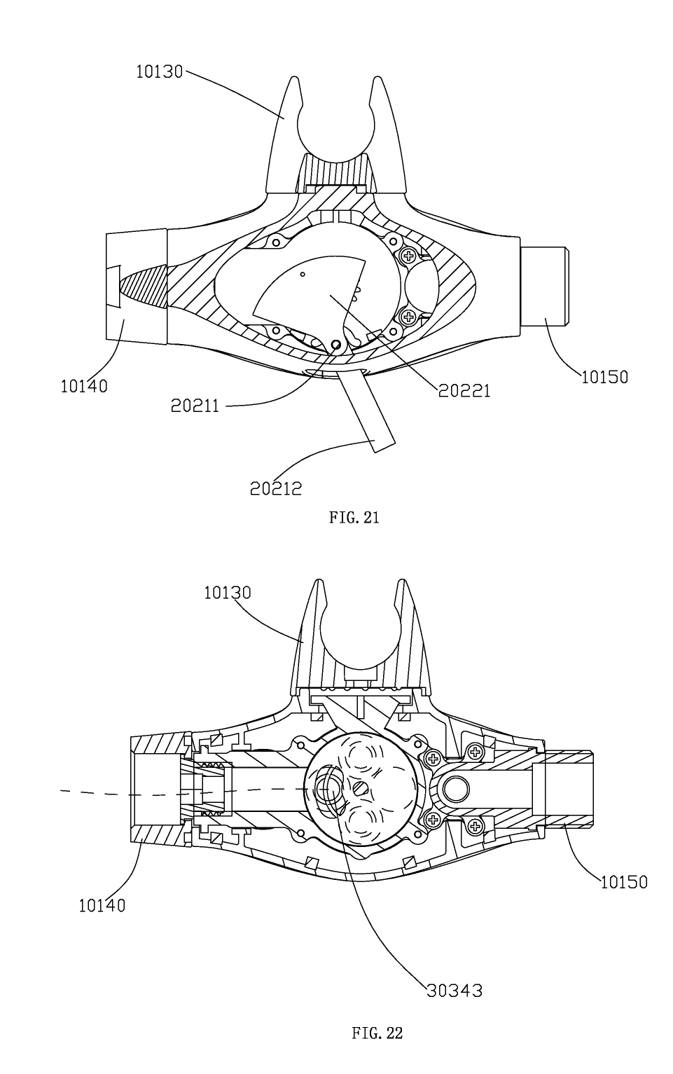

FIG. 11 to FIG. 22 illustrates the outlet switch of different waterway of the rocker switch valve of the preferred embodiment. In this embodiment, the three waterways of the rocker switch are separately connected to a head shower 50510, a side spray shower 50520 and a handheld shower 50530. thereinto, the head shower 50510 is directly connected to the outlet joint 10150; the side spray shower 50520 is connected to the switch valve by a support arm 50540, which is fixed to the wall; the handheld shower 50530 is connected to the switch valve by a flexible pipe 50550 and held to the socket 10130.

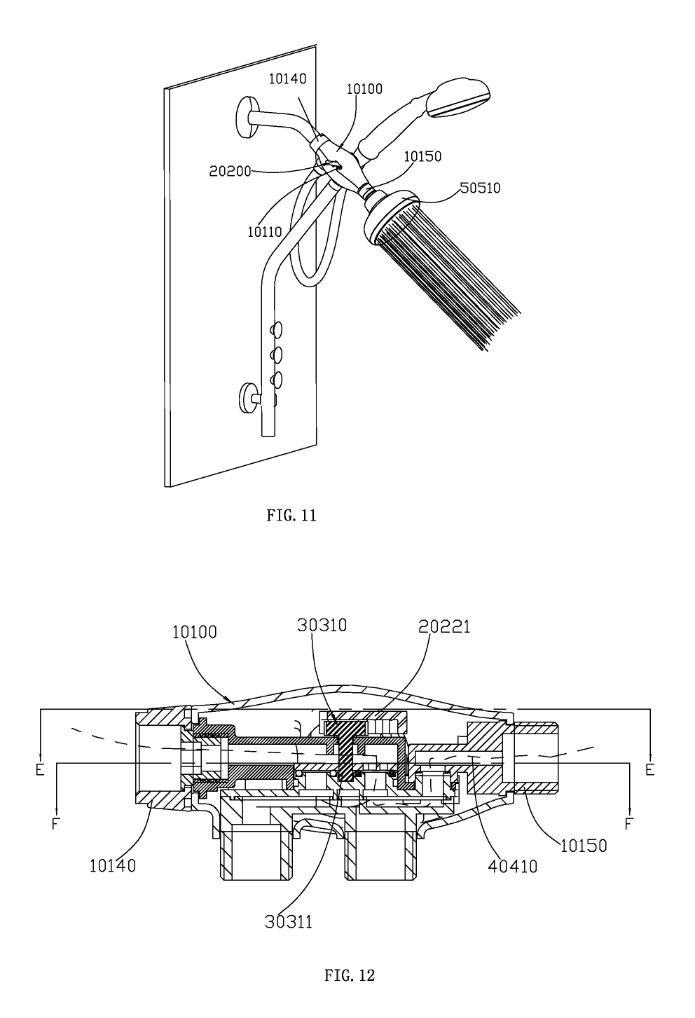

FIG. 12 to FIG. 14 illustrates the structure of this embodiment when the water flows out of the first waterway 40410.

Turn on the water source, the water flows to the rocker switch valve by the inlet joint 10140, and then switch the handle rod 20212 of the rocker 20200, the control portion will rotate synchronously with the water diversion unit 30300. Meanwhile the water diversion hole 30342 and 30343 of the water diversion body 30330 is closed up by the water diversion disk 30320, the water diversion hole 30341 is connected to the water hole 30321 and 30322, the water flows from the water diversion hole 30341 to the first waterway 40410, so that the water flows from the head shower 510, which is connected to the outlet joint 10150.

FIG. 15 to FIG. 18 illustrates the structure of this embodiment when the water flows out of the second waterway 40420.

Continue switch the handle rod 20212 of the rocker 20200, as the control portion is rotated synchronously with the water diversion unit 30300, the water diversion disk 30320 is rotated inside the groove 10121 and the water diversion hole 30341 and 30343 in the water diversion body 30330 is closed up by the water diversion disk 30320. the water diversion hole 30342 connected to the second waterway 40420 is connected to the water hole 30321 and 30322, then the water flows from the second water hole 40421, so the water flows from the side spray shower 50520.

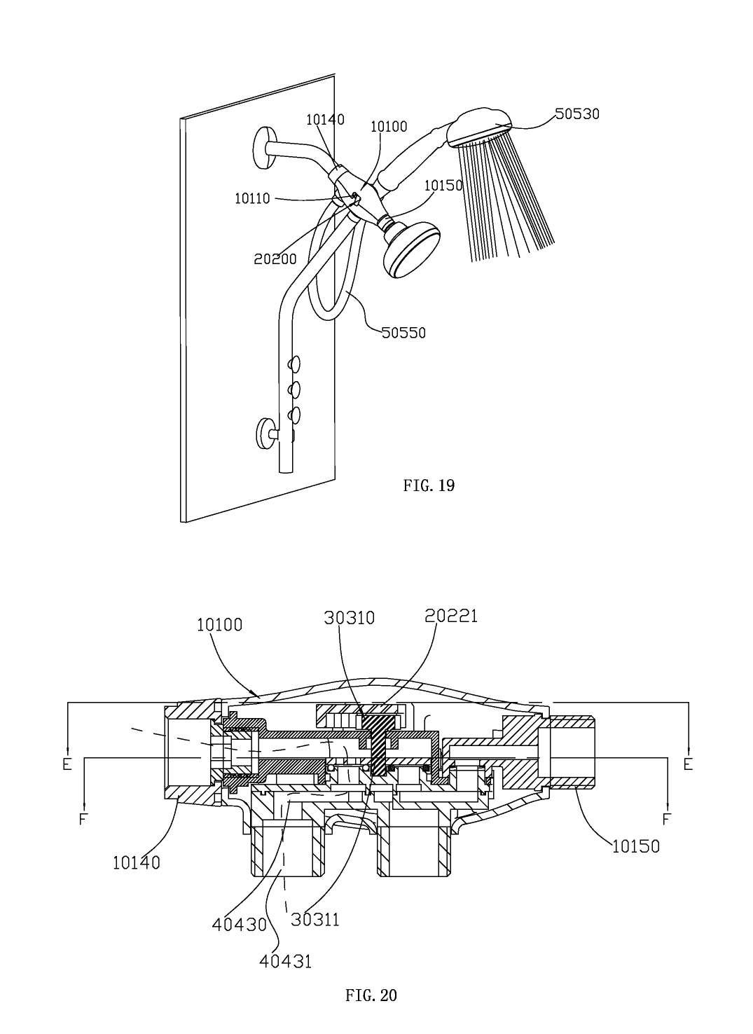

FIG. 19 to FIG. 22 illustrates the structure of this embodiment when the water flows out of the third waterway 40430.

Similarly, continue switch the handle rod 2012 of the rocker 20200, the water diversion hole 30341 and 30342 is closed up by the water diversion disk 30320, making the water hole 30321 and 30322 connected to the water diversion hole 30343. The water flows from the third outlet hole 40431, so the water flows from the handheld shower 50530.

Although the rocker switch valve of this preferred embodiment is applied for switch of different waterways 40410, 40420 and 40430, the present invention is not only limited by this. According to the same principle, the rocker switch valve can be applied in the same waterway of different outlets to realize different outlet effects in the same waterway. The detailed switch process will not be described here.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The rocker switch waterway mechanism of the present invention is provided with the switch of the switch valve between the first position and the second position with convenient by shaking the rocker up and down. The present invention is provided with not much switch force, and the switch is convenient with well industrial applicability.

1. A rocker switch waterway mechanism includes an inlet unit, at least two outlet units and a switch mechanism, wherein the switch mechanism includes a rocker and switch valve pin jointed together, the switch valve is disposed inside the cavity of the connection of the two outlet units, the rocker drives the switch valve to move between the inlets of the two outlet units to realize the switch of the two outlet units.

2. A rocker switch waterway mechanism according to the claim 1, wherein is connected to a first outlet unit and a second outlet unit, the switch mechanism includes an external pipe, an inner pipe, a connection base, a rocker and a switch valve; the external pipe is sleeved with the inner pipe and formed with an inlet cavity between the inner pipe and the external pipe to connect to the water source; the inner pipe is disposed with an inlet and an outlet, the outlet is connected to the first outlet unit; the connection base is fixed at the end of the external pipe and connected to the second outlet unit, the connection base is disposed with a water hole connected to the inlet cavity and the second outlet unit; the rocker is inserted into the connection base and swung between a first position and a second position relative to the connection base; the switch valve is connected to the rocker and slided inside the connection base; the water hole is sealed by the switch valve when the rocker is situated in the first position, the inlet cavity is connected to the inlet of the inner pipe, the water flows from the first outlet unit; the inlet of the inner pipe is sealed by the switch valve when the rocker is situated in the second position, the inlet cavity is connected to the water hole, the water flows from the second outlet unit.

3. A rocker switch waterway mechanism according to the claim 2, wherein the connection base includes a first water diversion body fixed in the lower of the external pipe and a joint fixed in the first water diversion body, the first water diversion body is hollow to form the water hole, the central of which is disposed with a circular boss.

4. A rocker switch waterway mechanism according to the claim 3, wherein the switch valve disposed with a sealing is passed through the water hole freely, the bottom surface of the sealing is withstood on the circular boss to seal the water hole when the rocker is situated in the first position; the inlet is sealed by the top surface of the sealing when the rocker is situated in the second position.

5. A rocker switch waterway mechanism according to the claim 2, wherein the rocker is disposed with an operating portion outside the connection base for the user's operation and a linkage portion inserted inside the connection base, the linkage portion is concaved disposed with a spherical cap groove of urn shaped; a sphere is disposed in the lower of the switch valve; the sphere is coupled to be accommodated inside the spherical cap groove, making the swinging of the rocker drive the switch valve to slide up and down.

6. A rocker switch waterway mechanism according to the claim 3, wherein the joint is disposed with an assembly groove, a waterway through up and down and an assembly hole connected to the assembly groove from up to down, the waterway is connected to the water hole of the first water diversion body and the second outlet unit, the lower of the switch valve is sealed and slided through the assembly hole, the linkage portion of the rocker is situated inside the assembly groove and connected to the lower of the switch valve.

7. A rocker switch waterway mechanism according to the claim 3, wherein the connection base further includes a second water diversion body, which includes an external sleeve, an inner sleeve and an interval connected the external sleeve and the inner sleeve, the upper of the external sleeve is sealed and screwed inside the external pipe, the lower of the external pipe is sealed and screwed inside the first water diversion body, the lower end face of the second water diversion body and the circular boss of the first water diversion is interval arranged, the inner sleeve is sealed and sleeved outside the inlet of the inner pipe.

8. A rocker switch waterway mechanism according to the claim 2, wherein the switch mechanism further includes a three way valve, which includes a first pipe connected to the water source, a second pipe and a third pipe, the second pipe is disposed with a first waterway connected to the first pipe and the inlet cavity and a second waterway connected to the outlet of the inner pipe and the first outlet unit.

9. A rocker switch waterway mechanism according to the claim 6, wherein further includes a cover, which is coupled to be sealed and fixed to the opening of the assembly groove, a jack is opened on the cover; fulcrums are separately disposed on the upper and lower side face of the jack, the outer end of the rocker is extended out of the connection base from the jack of the cover.

10. A rocker switch waterway mechanism according to the claim 6, wherein the shape of the jack on the cover is coupled to the shape of the outer surface of the rocker, the fulcrum is hemispherical.

11. A rocker switch waterway mechanism according to the claim 1, wherein includes a fixed unit, an operation unit, a water diversion unit and at least two waterway; thereinto:
The operation unit includes a rocker, the rocker is pin jointed to the fixed unit and disposed with a handle outside the fixed unit for the operation of the user and a control portion inside the fixed unit, a inner gear is disposed on the control portion;
The water diversion unit includes a driven gear rotationally disposed inside the fixed unit and a water diversion disk fixed to the driven gear of coaxial; the inner gear is engaged to the driven gear, the driven gear and the water diversion disk are rotated by the driven of the rotation of the rocker, the switch of different waterways is realized by the relative rotation of the water diversion disk and the fixed unit.

12. A rocker switch waterway mechanism according to the claim 11, wherein the control portion includes a fanning strip and a barricade extended downward from the outer arc ridge of the fanning strip, the inner side wall of the barricade is disposed with an inner gear, the centre of the circle of the fanning strip is fixed to the handle.

13. A rocker switch waterway mechanism according to the claim 11, wherein the handle includes a pin joint portion pin jointed to the fixed unit and a handle rod fixed to the pin joint portion, the handle rod is fixed in the lower of the pin joint portion, the fanning strip is fixed in the upper of the pin joint portion.

14. A rocker switch waterway mechanism according to the claim 11, wherein the fixed unit includes a body, the operation unit is situated on the top face of the body, the water diversion unit disposed on the bottom surface of the body includes a water diversion body coupled to the water diversion disk, the water diversion body is disposed with several water diversion holes separately connected to different waterway.

15. A rocker switch waterway mechanism according to the claim 14, wherein a groove is disposed on the bottom surface of the body, the water diversion disk is coupled to be accommodated inside the groove.

16. A rocker switch waterway mechanism according to the claim 11, wherein a shaft disposed in the lower of the driven gear to be fixed to the water diversion unit of coaxial.

17. A rocker switch waterway mechanism according to the claim 11, wherein the fixed unit is disposed with a groove, the handle rod is extended out of the groove for the control of the user and can be swung left and right inside the groove.

18. A rocker switch waterway mechanism according to the claim 11, wherein a socket is disposed in the fixed unit.
